(19) United States
(12) Patent Application Publication
(10) Pub. No.: US 2004/0227814 A1
(43) Pub. Date: Nov. 18, 2004

(54) Double exposure camera system of vehicle and image acquisition method thereof

(76) Inventor: Jang Don Choi, Tokyo (JP)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/642,001

(22) Filed: Aug. 15, 2003

(30) Foreign Application Priority Data
May 15, 2003 (KR) 10-2003-0030937

(51) Int. Cl. H04N 7/18

(52) U.S. Cl. 348/148; 348/143

(57) ABSTRACT

Regarding a double exposure scheme that synthesizes first and second images respectively obtained by first and second exposure periods for obtaining a final image outside of a vehicle, at least one adjusting parameter is calculated and thereby at least one of the first and second exposure periods is adjusted on the basis of the adjusting parameter.

### FIELD OF THE INVENTION

Generally, the present invention relates to a vehicle, and more particularly to a method for acquiring a road image from a vehicle and a double exposure camera system of a vehicle.

### BACKGROUND OF THE INVENTION

Recently, vehicles have begun to be equipped with cameras for various purposes, e.g., for controlling driving. For example, such camera may be provided in a vehicle for controlling the running of the vehicle on the basis of an image obtained by the camera. Such a camera system is under continuing investigation in order to obtain a better (clearer) image during nighttime driving circumstances as well as in the daytime.

In the nighttime, when outside light is incident on the camera such as from a headlight (especially when it is set to high-beam) from an oncoming vehicle, the camera cannot obtain a clear image by just one exposure because of the light of the oncoming vehicle. Therefore, in such a case, a clearer image may be obtained by reducing the effect of the oncoming light, e.g., by synthesizing two images obtained with respective short and long exposures.

Such an image acquisition method wherein two images respectively obtained by different exposures, e.g. different shutter speeds, are synthesized to form a final image is called a double exposure method. A camera system that obtains a final road image according to such a double exposure method is called a double exposure camera system.

According to the prior art, values of an exposure parameter (e.g., shutter speed) that indicate a degree of the exposure are fixed to two values. That is, the final image is obtained by synthesizing two images obtained by two fixed values of the exposure parameter, without considering the initial image obtained by the camera, nor considering the current running circumstances of the vehicle.

However, it is notable that a vehicle can run in a variety of circumstances, such as existence or non-existence of an oncoming vehicle, daytime or nighttime, and city or suburban areas. Therefore, it is expected by the inventor of the present invention that synthesizing images of two fixed values of exposure parameters should not be sufficient to obtain a sufficiently clear image in all running circumstances of the vehicle.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a camera system and a method for obtaining an image outside of a vehicle wherein an exposure parameter may be varied under the consideration of running circumstances of a vehicle and/or initially obtained images.

An exemplary camera system for obtaining an image outside of a vehicle according to an embodiment of the present invention includes a camera equipped at the vehicle; an image synthesizer for receiving a plurality of initial images including first and second images according to first and second exposure periods respectively, and for synthesizing the received first and second images; and a control unit for controlling the camera, the control unit calculating at least one adjusting parameter and adjusting at least one of the first and second exposure periods of the camera on the basis of the adjusting parameter.

It is preferable that the at least one adjusting parameter includes at least one vehicle parameter that varies according to a running state of the vehicle.

It is preferable that the exemplary camera system further includes a vehicle speed detector for detecting a speed of the vehicle, and the vehicle parameter includes the vehicle speed.

It is also preferable that the exemplary camera system further includes a lateral acceleration detector for detecting a lateral acceleration of the vehicle, and the vehicle parameter includes the lateral acceleration.

It is also preferable that the exemplary camera system further includes a steering angle detector for detecting a steering angle of the vehicle, and the vehicle parameter includes the steering angle.

It is also preferable that the exemplary camera system further includes a wiper speed detector for detecting a wiper speed of the vehicle, and the vehicle parameter includes the wiper speed.

It is also preferable that the exemplary camera system further includes a brightness detector for detecting a brightness outside of the vehicle, and the vehicle parameter includes the outside brightness.

It is also preferable that the exemplary camera system further includes a navigation system for determining at least one of a current time and a current driving region, and the vehicle parameter includes the at least one of the current time and the current driving region.

It is further preferable that the vehicle parameter includes at least two among a vehicle speed, a lateral acceleration, a steering angle, a wiper speed, a brightness outside of the vehicle, and a current time and/or a current driving region of a navigation system.

It is preferable that the at least one adjusting parameter includes at least one image parameter obtained on the basis of at least one image of the first and second images.

It is preferable that the image parameter includes an area index corresponding to an area having luminance greater than a predetermined luminance on the at least one image. In this case, it is further preferable that the control unit determines whether the area index is greater than a predetermined value, and the control unit adjusts the exposure period of the at least one image when the area index is greater than the predetermined value.

It is preferable that the image parameter includes an area index corresponding to an area having luminance less than a predetermined luminance on the at least one image. In this case, it is further preferable that the control unit determines whether the area index is greater than a predetermined value, and the control unit adjusts the exposure period of the at least one image when the area index is greater than the predetermined value.

It is preferable that the image parameter includes a luminance index of maximum frequency corresponding to a most frequent luminance of pixels on the at least one image. In this case, it is further preferable that the control unit compares the luminance index of maximum frequency with a predetermined range, and the control unit adjusts the exposure period of the at least one image when the luminance index of maximum frequency is out of the predetermined range.

It is preferable that the image parameter includes a luminance index of an oncoming lane (an opposing lane) corresponding to whether a region having luminance greater than a predetermined luminance exists in a portion corresponding to the oncoming lane in the at least one image, and the control unit adjusts the exposure period of the at least one image when the luminance index of the oncoming lane indicates that the region having luminance greater than the predetermined luminance exists in the portion corresponding to the oncoming lane in the at least one image.

It is preferable that the image parameter includes a luminance index of a shoulder region corresponding to whether a region having luminance greater than a predetermined luminance exists in a portion outside vehicle lanes in the at least one image, and the control unit adjusts the exposure period of the at least one image when the luminance index of the shoulder region indicates that the region having luminance greater than the predetermined luminance exists in the portion outside the vehicle lanes in the at least one image.

It is preferable that the image parameter includes at least two among a first area index corresponding to an area having luminance greater than a predetermined luminance on the at least one image, a second area index corresponding to an area having luminance less than a predetermined luminance on the at least one image, a luminance index of maximum frequency corresponding to a most frequent luminance of pixels on the at least one image, a luminance index of an oncoming lane corresponding to whether a region having luminance greater than a predetermined luminance exists in a portion corresponding to the oncoming lane in the at least one image, and a luminance index of a shoulder region corresponding to whether a region having luminance greater than a predetermined luminance exists in a portion outside vehicle lanes in the at least one image.

It is preferable that the at least one adjusting parameter includes at least one vehicle parameter that varies according to a running state of the vehicle and at least one image parameter obtained on the basis of at least one image of the first and second images.

An exemplary method for obtaining an image outside of a vehicle according to an embodiment of the present invention includes obtaining a first image by the camera according to a first exposure period, obtaining a second image by the camera according to a second exposure period, synthesizing the first and second images, calculating at least one adjusting parameter, and adjusting at least one of the first and second exposure periods on the basis of the adjusting parameter.

It is preferable that the at least one adjusting parameter includes at least one vehicle parameter that varies according to a running state of the vehicle. In this case, it is further preferable that the vehicle parameter includes at least one among a vehicle speed, a lateral acceleration, a steering angle, a wiper speed, a brightness outside of the vehicle, and a current time and/or a current driving region of a navigation system.

It is preferable that the at least one adjusting parameter includes at least one image parameter obtained on the basis of at least one image of the first and second images. In this case, it is further preferable that the image parameter includes at least one among a first area index corresponding to an area having luminance greater than a predetermined luminance on the at least one image, a second area index corresponding to an area having luminance less than a predetermined luminance on the at least one image, a luminance index of maximum frequency corresponding to a most frequent luminance of pixels on the at least one image, a luminance index of an oncoming lane corresponding to whether a region having luminance greater than a predetermined luminance exists in a portion corresponding to the oncoming lane in the at least one image, and a luminance index shoulder region corresponding to whether a region having luminance greater than a predetermined luminance exists in a portion outside vehicle lanes in the at least one image.

It is further preferable that the image parameter includes an area index corresponding to an area having luminance greater than a predetermined luminance on the at least one image, and the adjusting at least one of the first and second exposure periods includes determining whether the area index is greater than a predetermined value, and adjusting the exposure period of the at least one image when the area index is greater than the predetermined value.

It is further preferable that the image parameter includes an area index corresponding to an area having luminance less than a predetermined luminance on the at least one image, and the adjusting at least one of the first and second exposure periods includes determining whether the area index is greater than a predetermined value, and adjusting the exposure period of the at least one image when the area index is greater than the predetermined value.

It is further preferable that the image parameter includes a luminance index of maximum frequency corresponding to a most frequent luminance of pixels on the at least one image, and the adjusting at least one of the first and second exposure periods includes comparing the luminance index of maximum frequency with a predetermined range, and adjusting the exposure period of the at least one image when the luminance index of maximum frequency is out of the predetermined range.

It is further preferable that the image parameter includes a luminance index of an oncoming lane corresponding to whether a region having luminance greater than a predetermined luminance exists in a portion corresponding to the oncoming lane in the at least one image, and the adjusting at least one of the first and second exposure periods adjusts the exposure period of the at least one image when the luminance index of the oncoming lane indicates that the region having luminance greater than the predetermined luminance exists in the portion corresponding to the oncoming lane in the at least one image.

It is further preferable that the image parameter includes a luminance index of a shoulder region corresponding to whether a region having luminance greater than a predetermined luminance exists in a portion outside vehicle lanes in the at least one image, and the adjusting at least one of the first and second exposure periods adjusts the exposure period of the at least one image when the luminance index of the shoulder region indicates that the region having luminance greater than the predetermined luminance exists in the portion outside vehicle lanes in the at least one image.

It is preferable that the at least one adjusting parameter includes at least one vehicle parameter that varies according to a running state of the vehicle and at least one image parameter obtained on the basis of at least one image of the first and second images.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a camera system of a vehicle according to an embodiment of the present invention;

FIG. 2 is a flowchart showing a double exposure image acquisition method according to an embodiment of the present invention; and

FIG. 3 is a detailed flowchart showing a step of adjusting an exposure period included in a double exposure image acquisition method according to an embodiment of the present invention.

### DETAILED DESCRIPTION OF THE PREFERRED EMBODIMENTS

A preferred embodiment of the present invention will hereinafter be described in detail with reference to the accompanying drawings.

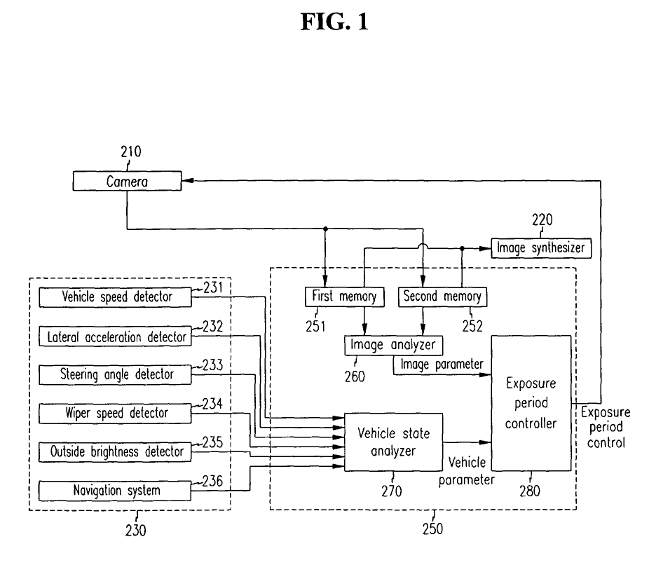

As shown in FIG. 1, the embodiment of the present invention provides a camera system 200 for obtaining an image outside of a vehicle, including a camera 210 equipped at the vehicle, an image synthesizer 220 for receiving first and second images of the camera 210 according to first and second exposure periods respectively and for synthesizing the received first and second images, and a control unit 250 for controlling the camera 210. The control unit 250 calculates at least one adjusting parameter, and adjusts at least one of the first and second exposure periods of the camera 210 on the basis of the adjusting parameter.

The control unit 250 includes first and second memories 251 and 252 for storing the first and second images respectively. The image synthesizer 220 retrieves the first and second images from the first and second memories 251 and 252 and accordingly synthesizes them. The at least one adjusting parameter for adjusting the exposure period includes vehicle parameters that may vary according to a running state of the vehicle, such that the exposure period may be kept appropriately tuned to the running state of the vehicle.

In a preferred embodiment, the vehicle parameters include a vehicle speed, a lateral acceleration, a steering angle, a wiper speed, a brightness outside of the vehicle, a current time, and a current driving region of the vehicle, such that at least one of them is collectively considered to determine an appropriate exposure period of the first and second exposure periods. For the detection of such parameters, the camera system of the present embodiment includes a detector unit 230 for determining a current running state of the vehicle.

The detector unit 230 includes a vehicle speed detector 231 for detecting the speed of the vehicle, a lateral acceleration detector 232 for detecting the lateral acceleration of the vehicle, a steering angle detector 233 for detecting the steering angle of the vehicle, a wiper speed detector 234 for detecting the wiper speed of the vehicle, a brightness detector 235 for detecting the brightness outside of the vehicle, and a navigation system 236 for determining the current time and the current driving region of the vehicle.

Each of the detectors 231-235 may be realized by a conventional sensor selectable by a person skilled in the art for detecting a value of a corresponding parameter based on the teachings herein. The navigation system 236 may determine the current driving region on a predetermined digital map based on signals from a GPS satellite (not shown), and the current time may be arbitrarily and obviously determined by various methods known to a person in the art.

Signals from the detectors 231-235 and the navigation system 236 are transmitted to the control unit 250, and the vehicle state analyzer 270 of the control unit 250 calculates vehicle parameters on the basis of the received signals. The vehicle state analyzer 270, e.g., may convert the received values to normalized digital values and calculate the vehicle parameters based on the normalized digital values. The control unit 250 can adjust the exposure period of the camera 210 on the basis of such calculated vehicle parameters.

In addition, a preferred embodiment further enhances the clarity of the final image by analyzing initially-obtained first and second images. For this purpose, the at least one adjusting parameter for adjusting the exposure periods includes image parameters obtained from at least one image of the first and second images.

According to a preferred embodiment, the image parameters include a first area index corresponding to an area having luminance greater than a predetermined luminance on the at least one image, a second area index corresponding to an area having luminance less than a predetermined luminance on the at least one image, a luminance index of maximum frequency corresponding to a most frequent luminance of pixels on the at least one image, a luminance index of an oncoming lane (opposing lane) corresponding to whether a region having luminance greater than a predetermined luminance exists in a portion corresponding to the oncoming lane in the at least one image, and a luminance index of a shoulder region corresponding to whether a region having luminance greater than a predetermined luminance exists in a portion outside vehicle lanes in the at least one image, such that at least one of them are collectively considered to determine an appropriate exposure for the first and second exposure periods.

For calculation of such image parameters, the control unit 250 is provided with an image analyzer 260. The image analyzer 260 calculates the first and second area indexes, the luminance index of maximum frequency, the luminance index of the oncoming lane, and the luminance index of the shoulder region on the basis of the first and second images stored in the first and second memories 251 and 252.

For the adjustment of the exposure periods of the camera, the control unit 250 is provided with an exposure period controller 280. The exposure period controller 280 calculates the first and second exposure periods of the camera on the basis of the vehicle parameters obtained by the vehicle state analyzer 270 and image parameters obtained by the image analyzer 260. The exposure period controller 280 accordingly controls the camera on the basis of the calculated first and second exposure periods.

The control unit 250 can be realized by one or more processors activated by predetermined software. The vehicle state analyzer 270, the image analyzer 260, and the exposure period controller 280 may form parts of the predetermined software. The predetermined software can be programmed by a person of ordinary skill in the art to perform each step of a method for obtaining an image outside of the vehicle according to a preferred embodiment of the present invention based on the teaching of the invention as herein presented.

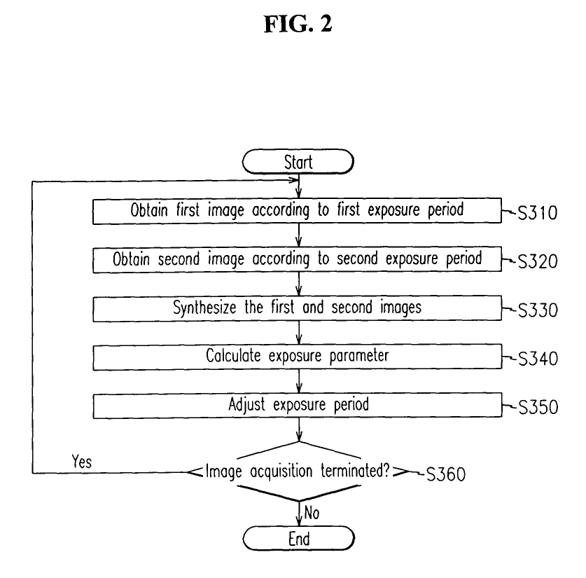

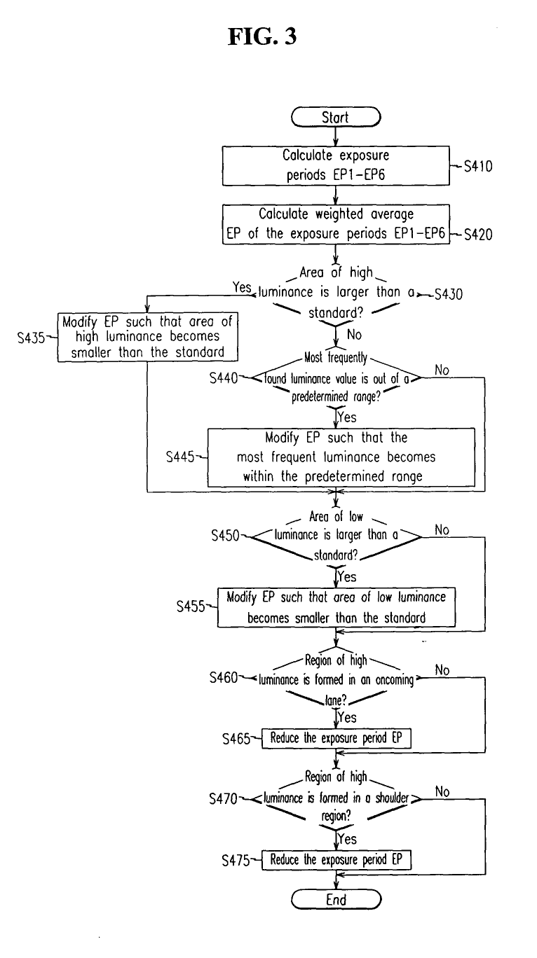

A method for obtaining an image outside a vehicle according to a preferred embodiment of the present invention is hereinafter described in detail with reference to FIG. 2 and FIG. 3.

Firstly, the control unit 250 receives an image signal (first image signal) from the camera 210 and stores it in the first memory 251 at step S310, and then receives another image signal (second image signal) from the camera 210 and stores it in the second memory 252 at step S320.

Subsequently, the image synthesizer 220 synthesizes an image from the first and second images at step S330.

The control unit 250 calculates the adjusting parameters for adjusting the exposure period, i.e., the vehicle parameters and the image parameters, at step S340.

At the step S340 of calculating parameters, the image analyzer 260 calculates the image parameters on the basis of the first and second images stored in the first and second memories 251 and 252, and the vehicle state analyzer 270 calculates the vehicle parameters on the basis of inputs from the detectors 231-235 and the navigation system 236.

In more detail, the vehicle state analyzer 270 converts signals from the detectors 231-235 to digital data, and the information related to the current time and current running region obtained from the navigation system 236 to predetermined codes.

In connection with the first image, the image analyzer 260 calculates image parameters, i.e., the first and second area index, the luminance index of maximum frequency, the luminance index of an oncoming lane, and the luminance index of the shoulder region. In connection with the second image, the image analyzer 260 calculates the same image parameters.

According to a preferred embodiment, the first exposure period is adjusted on the basis of the vehicle parameters and such image parameters in connection with the first image, and the second exposure period is adjusted on the basis of the vehicle parameters and such image parameters in connection with the second image.

The image parameters related to the first image and adjustment of the first exposure time on the basis thereof are hereinafter described in detail. The image parameters related to the first image and adjustment of the first exposure time on the basis thereof are the same as and obvious from the description related to the first image.

When the exposure period adjusting parameters are calculated at step S340, the controller 280 adjusts the first and second exposure periods on the basis of the calculated vehicle and image parameters at step S350.

When the first and second exposure periods are adjusted, the controller 280 determines at step S360 whether obtaining of the images is to be terminated. If the obtaining of the images is not to be terminated, the process recursively proceeds to the step S310 of obtaining the first image.

When the steps S310 and S320 of obtaining the first and second images are newly executed, the new first and second images are obtained according to the adjusted first and second exposure periods. Therefore, in this double exposure image acquisition, the new image becomes optimal having the immediately previous images and running state of the vehicle taken into consideration.

The step S360 of adjusting the exposure period is hereinafter described in detail with reference to FIG. 3.

Firstly at step S410, the exposure period controller 280 calculates exposure periods each of which corresponds to each of the vehicle parameters.

At step S410, the controller 280 respectively calculates an exposure period EP1 corresponding to the current vehicle speed, an exposure period EP2 corresponding to the current lateral acceleration, an exposure period EP3 corresponding to the current steering angle, an exposure period EP4 corresponding to the current wiper speed, an exposure period EP5 corresponding to the current brightness outside of the vehicle, an exposure period EP6 corresponding to the current time, and an exposure period EP7 corresponding to the current running region.

The exposure periods EP1-EP7 corresponding to the vehicle parameters may be retrieved from predetermined look-up tables. Specific data stored in the look-up tables may be obviously set as appropriate values according to a person of ordinary skill in the art without excessive experiments. However, it is notable that one can consider the following standards for better results.

Regarding the vehicle speed, the whole speed range may be split into a few ranges, for example, a low speed range such as in city running circumstances, a high speed range such as on a highway, and an intermediate speed range between the low and high speed ranges.

Regarding the lateral acceleration, the exposure period is preferably optimized to most clearly identify distant objects when the lateral acceleration is low (e.g., a straight road), and preferably optimized to most clearly identify close objects when the lateral acceleration is high (e.g., a sharp curve).

In the same way, regarding the steering angle, the exposure period is preferably optimized to most clearly identify distant objects when the steering angle is low (e.g., a straight road), and preferably optimized to most clearly identify close objects when the steering angle is high (e.g., a sharp curve).

When the exposure periods EP1-EP7 corresponding to the vehicle parameters are calculated, the exposure period controller 280 calculates, at step S420, an exposure period EP by multiplying each exposure period EP1-EP7 with each corresponding weight factor wf1-wf7 and summing them to finally calculate a weighted average of the exposure periods EP1-EP7.

Such calculated exposure period EP is modified on the basis of image parameters obtained by the image analyzer 260.

Firstly, the exposure period controller 280 determines whether the first area index is greater than a first area reference at step S430. According to the step S430, it can be determined if the bright region is excessively large on the image.

When the first area index is greater than a first area reference at step S430, the exposure period EP is modified at step S435 to a value such that the first area index becomes less than the first area reference. The first area reference and the amount of modification of the exposure period EP may be obviously set by a person of ordinary skill in the art.

According to the modification of the exposure period in the step S435, the total area of a bright region can be limited.

When the first area index is not greater than the first area reference at the step S430, the controller 280 determines at step S440 whether the luminance index of maximum frequency is out of a predetermined luminance range. According to the step S440, it can be determined whether the number of pixels showing luminance out of preferable luminance range is excessive.

When the luminance index of maximum frequency is out of the predetermined luminance at the step S440, the exposure period EP is modified at step S445 to a value such that the luminance index of maximum frequency becomes within the predetermined luminance range. The luminance range and the amount of modification of the exposure period EP may be obviously set by a person of ordinary skill in the art.

According to the modification of the exposure period in the step S435, the number of pixels whose luminance is out of the preferable range can be limited.

In addition, at step S450, the exposure period controller 280 determines whether the second area index is greater than a second area reference. According to the step S450, it can be determined whether a dark region is excessively large on the image.

When the second area index is greater than the second area reference at the step S450, the exposure period EP is modified at step S455 to a value such that the second area index becomes less than the second area reference. The second area reference and the amount of modification of the exposure period EP may be obviously set by a person of ordinary skill in the art.

According to the modification of the exposure period in the step S455, the total area of the dark region can be limited.

In addition, at step S460, the exposure period controller 280 determines, on the basis of the luminance index of an oncoming lane, whether a region having luminance greater than a predetermined luminance is formed on a portion corresponding to an oncoming lane by more than a predetermined size. According to the step S460, it can be determined whether an excessively bright light source (e.g., an oncoming vehicle having its headlights turned on) exists in the oncoming lane.

When a region having luminance greater than the predetermined luminance is formed on the portion corresponding to an oncoming lane by more than the predetermined size at the step S460, the exposure period is adjusted (i.e., reduced) at step S465. According to such modification of the exposure period in the step S465, appropriate exposure can be maintained in the case that an oncoming vehicle is in an oncoming lane.

In addition, the exposure period controller 280 determines at step S470, on the basis of the luminance index of the shoulder region, whether a region having luminance greater than a predetermined luminance exists in a portion outside vehicle lanes by more than a predetermined size. According to the step S470, it can be determined whether an excessively bright light source exists in the shoulder region.

When a region having luminance greater than the predetermined luminance exists in a portion outside vehicle lanes by more than a predetermined size at the step S470, the exposure period is adjusted (i.e., reduced) at step S475.

In the above description, processes for adjusting the first exposure period in connection with the first image are explained. As described above, the adjustment of the second exposure period in connection with the second image is executed in the same processes described above on the basis of the same parameters.

However, it is notable that specific values of the predetermined values such as the first and second area references, and the predetermined luminance range set correspondingly to the luminance index of maximum frequency, may be preset independently with respect to the first image and the second image.

According to an embodiment of the present invention, an image finally obtained by a camera system of a vehicle may be optimized for all running circumstances of the vehicle.

For example, the exposure periods may be optimally varied according to vehicle speed. In more detail, the exposure periods may be preferably varied to a value that enables distant objects (which usually appear dark) to become clearer in the case of high vehicle speed.

In addition, such exposure periods may be optimally varied to a value that enables close objects to become clearer in the case of a corner.

In addition the wiper speed is also taken into account such that a better image is ensured in the case of rainy weather.

Furthermore, brightness outside of the vehicle is taken into account such that the exposure period changes adaptively to the brightness of the current driving circumstances.

In addition, the obtained images are analyzed and are also taken into account such that the final image may be enhanced better.

In more detail, regarding the images, factors such as the sizes of bright and dark regions, the existence of a light source in an oncoming lane, and the existence of a light source in a shoulder region are also considered to adjust exposure periods, and therefore obtaining a final image of a better quality is ensured.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A camera system for obtaining an image outside of a vehicle, comprising:
a camera;
an image synthesizer for receiving a plurality of initial images including first and second images according to first and second exposure periods respectively, and for synthesizing the received first and second images; and
a control unit for controlling the camera, the control unit calculating at least one adjusting parameter and adjusting at least one of the first and second exposure periods of the camera on the basis of the adjusting parameter.

2. The camera system of claim 1, wherein the at least one adjusting parameter comprises at least one vehicle parameter that varies according to a running state of the vehicle.

3. The camera system of claim 2, further comprising a vehicle speed detector for detecting a speed of the vehicle, wherein the vehicle parameter comprises the vehicle speed.

4. The camera system of claim 2, further comprising a lateral acceleration detector for detecting a lateral acceleration of the vehicle, wherein the vehicle parameter comprises the lateral acceleration.

5. The camera system of claim 2, further comprising a steering angle detector for detecting a steering angle of the vehicle, wherein the vehicle parameter comprises the steering angle.

6. The camera system of claim 2, further comprising a wiper speed detector for detecting a wiper speed of the vehicle, wherein the vehicle parameter comprises the wiper speed.

7. The camera system of claim 2, further comprising a brightness detector for detecting a brightness outside of the vehicle, wherein the vehicle parameter comprises the outside brightness.

8. The camera system of claim 2, further comprising a navigation system for determining at least one of a current time and a current driving region, wherein the vehicle parameter comprises the at least one of the current time and the current driving region.

9. The camera system of claim 2, wherein the vehicle parameter comprises at least two among a vehicle speed, a lateral acceleration, a steering angle, a wiper speed, a brightness outside of the vehicle, and a current time and/or a current driving region of a navigation system.

10. The camera system of claim 1, wherein the at least one adjusting parameter comprises at least one image parameter obtained on the basis of at least one image of the first and second images.

11. The camera system of claim 10, wherein the image parameter comprises an area index corresponding to an area having luminance greater than a predetermined luminance on the at least one image.

12. The camera system of claim 11, wherein:
the control unit determines whether the area index is greater than a predetermined value; and
the control unit adjusts the exposure period of the at least one image when the area index is greater than the predetermined value.

13. The camera system of claim 10, wherein the image parameter comprises an area index corresponding to an area having luminance less than a predetermined luminance on the at least one image.

14. The camera system of claim 13, wherein:
the control unit determines whether the area index is greater than a predetermined value; and
the control unit adjusts the exposure period of the at least one image when the area index is greater than the predetermined value.

15. The camera system of claim 10, wherein the image parameter comprises a luminance index of maximum frequency corresponding to a most frequent luminance of pixels on the at least one image.

16. The camera system of claim 15, wherein:
the control unit compares the luminance index of maximum frequency with a predetermined range; and
the control unit adjusts the exposure period of the at least one image when the luminance index of maximum frequency is out of the predetermined range.

17. The camera system of claim 10, wherein:
the image parameter comprises a luminance index of an oncoming lane corresponding to whether a region having luminance greater than a predetermined luminance exists in a portion corresponding to the oncoming lane in the at least one image; and
the control unit adjusts the exposure period of the at least one image when the luminance index of the oncoming lane indicates that the region having luminance greater than the predetermined luminance exists in the portion corresponding to the oncoming lane in the at least one image.

18. The camera system of claim 10, wherein:
the image parameter comprises a luminance index of a shoulder region corresponding to whether a region having luminance greater than a predetermined luminance exists in a portion outside vehicle lanes in the at least one image; and
the control unit adjusts the exposure period of the at least one image when the luminance index of the shoulder region indicates that the region having luminance greater than the predetermined luminance exists in the portion outside the vehicle lanes in the at least one image.

19. The camera system of claim 10, wherein the image parameter comprises at least two among:
a first area index corresponding to an area having luminance greater than a predetermined luminance on the at least one image;
a second area index corresponding to an area having luminance less than a predetermined luminance on the at least one image;
a luminance index of maximum frequency corresponding to a most frequent luminance of pixels on the at least one image;
a luminance index of an oncoming lane corresponding to whether a region having luminance greater than a predetermined luminance exists in a portion corresponding to the oncoming lane in the at least one image; and
a luminance index of a shoulder region corresponding to whether a region having luminance greater than a predetermined luminance exists in a portion outside vehicle lanes in the at least one image.

20. The camera system of claim 1, wherein the at least one adjusting parameter comprises at least one vehicle parameter that varies according to a running state of the vehicle and at least one image parameter obtained on the basis of at least one image of the first and second images.

21. A method for obtaining an image outside of a vehicle using a camera system, comprising:
obtaining a first image at a first exposure period;
obtaining a second image at a second exposure period;
synthesizing the first and second images;
calculating at least one adjusting parameter; and
adjusting at least one of the first and second exposure periods on the basis of the adjusting parameter.

22. The method of claim 21, wherein the at least one adjusting parameter comprises at least one vehicle parameter that varies according to a running state of the vehicle.

23. The method of claim 22, wherein the vehicle parameter comprises at least one among a vehicle speed, a lateral acceleration, a steering angle, a wiper speed, a brightness outside of the vehicle, and a current time and/or a current driving region of a navigation system.

24. The method of claim 21, wherein the at least one adjusting parameter comprises at least one image parameter obtained on the basis of at least one image of the first and second images.

25. The method of claim 24, wherein the image parameter comprises at least one among:
a first area index corresponding to an area having luminance greater than a predetermined luminance on the at least one image;
a second area index corresponding to an area having luminance less than a predetermined luminance on the at least one image;
a luminance index of maximum frequency corresponding to a most frequent luminance of pixels on the at least one image;
a luminance index of an oncoming lane corresponding to whether a region having luminance greater than a predetermined luminance exists in a portion corresponding to the oncoming lane in the at least one image; and
a luminance index shoulder region corresponding to whether a region having luminance greater than a predetermined luminance exists in a portion outside vehicle lanes in the at least one image.

26. The method of claim 25, wherein the image parameter comprises an area index corresponding to an area having luminance greater than a predetermined luminance on the at least one image, and the adjusting at least one of the first and second exposure periods comprises:
determining whether the area index is greater than a predetermined value; and
adjusting the exposure period of the at least one image when the area index is greater than the predetermined value.

27. The method of claim 25, wherein the image parameter comprises an area index corresponding to an area having luminance less than a predetermined luminance on the at least one image, and the adjusting at least one of the first and second exposure periods comprises:
determining whether the area index is greater than a predetermined value; and
adjusting the exposure period of the at least one image when the area index is greater than the predetermined value.

28. The method of claim 25, wherein the image parameter comprises a luminance index of maximum frequency corresponding to a most frequent luminance of pixels on the at least one image, and the adjusting at least one of the first and second exposure periods comprises:
comparing the luminance index of maximum frequency with a predetermined range; and
adjusting the exposure period of the at least one image when the luminance index of maximum frequency is out of the predetermined range.

29. The method of claim 25, wherein:
the image parameter comprises a luminance index of an oncoming lane corresponding to whether a region having luminance greater than a predetermined luminance exists in a portion corresponding to the oncoming lane in the at least one image; and
the adjusting at least one of the first and second exposure periods adjusts the exposure period of the at least one image when the luminance index of the oncoming lane indicates that the region having luminance greater than the predetermined luminance exists in the portion corresponding to the oncoming lane in the at least one image.

30. The method of claim 25, wherein:
the image parameter comprises a luminance index of a shoulder region corresponding to whether a region having luminance greater than a predetermined luminance exists in a portion outside vehicle lanes in the at least one image; and
the adjusting at least one of the first and second exposure periods adjusts the exposure period of the at least one image when the luminance index of the shoulder region indicates that the region having luminance greater than the predetermined luminance exists in the portion outside vehicle lanes in the at least one image.

31. The method of claim 21, wherein the at least one adjusting parameter comprises at least one vehicle parameter that varies according to a running state of the vehicle and at least one image parameter obtained on the basis of at least one image of the first and second images.
